(19) United States
(12) Patent Application Publication
(10) Pub. No.: US 2009/0168299 A1
(43) Pub. Date: Jul. 2, 2009

(54) METHOD FOR THE PRODUCTION OF A COATING OF A POROUS, ELECTRICALLY CONDUCTIVE SUPPORT MATERIAL WITH A DIELECTRIC, AND PRODUCTION OF CAPACITORS HAVING HIGH CAPACITY DENSITY WITH THE AID OF SAID METHOD

(75) Inventor: Florian Thomas, Hassloch (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF SE, Ludwigshafen (DE)

(21) Appl. No.: 12/296,466

(22) PCT Filed: Apr. 16, 2007
(86) PCT No.: PCT/EP2007/053672

§ 371 Date: Oct. 8, 2008

(30) Foreign Application Priority Data
Apr. 26, 2006 (EP) 06113141.3

(51) Int. Cl. H01G 4/06; B05D 5/12

(52) U.S. Cl. 361/311; 427/79

(57) ABSTRACT

The present invention relates to a method for producing a coating of a porous, electrically conductive substrate material with a dielectric by using a solution of precursor compounds of the dielectric with a concentration of less than 10 wt. %, expressed in terms of the contribution of the dielectric to the total weight of the solution, and to the production of capacitors using this method.

The present invention relates to a method for producing a continuous and low-defect coating on a porous, electrically conductive substrate material with a dielectric, and to the production of high capacitance density capacitors by using this method.

The storage of energy in a wide variety of applications is the subject of continuing development work. The progressive miniaturization of electrical and electronic circuits is leading to a demand for fewer and fewer or smaller and smaller components, in order to achieve this storage. For capacitors, therefore, higher and higher capacitance densities are required.

According to the capacitor formulae

E=½C·U² and C=ε·ε₀·A/d,

where: E=energy
C=capacitance
U=voltage
ε=dielectric constant of the dielectric
ε₀=permittivity of free space
A=electrode surface area
d=electrode spacing,

high energy densities can be achieved by using dielectrics with high dielectric constants, as well as by large electrode surface areas and short electrode spacings. The use of dielectrics with a high breakdown voltage is furthermore desirable in order to achieve high operating voltages.

Tantalum capacitors consist of a sintered tantalum powder base body. They therefore have very large electrode surface areas but, owing to their electrochemical production, they are restricted to tantalum pentoxide as a dielectric with only a low dielectric constant (ε=27). The electrochemical production process furthermore limits the overall size of the capacitors to a few millimeters, so that elaborate parallel connection of capacitors (so-called “multi-anode” capacitors) is necessary in order to provide larger capacitances.

Multilayer ceramic capacitors (MLCCs) tolerate high voltages and ambient temperatures owing to the use of a ceramic dielectric. Ceramic dielectrics with high dielectric constants are furthermore available. However, the requirement for large electrode surface areas entails a large number of layers (>500) with a very small layer thickness (<1 μm). The production of such capacitors is therefore expensive and often prone to defects as the thickness of the layers increases. Likewise, it is not possible to produce capacitors with sizeable dimensions since this would lead to stress cracks when fabricating the layer structure, and therefore to failure of the component.

With rated voltages of about 6 V, for example, tantalum or ceramic multilayer capacitors have typical capacitance densities of around 10 mF/cm³.

DE-A-0221498 describes a high energy density ceramic capacitor which consists of an inert porous substrate, onto which an electrically conductive first layer, a second layer of barium titanate and another electrically conductive layer are applied. To this end, an inert porous substrate made of a material such as aluminum oxide is first coated with a metallization by vapor deposition or electroless plating. In a second step, the dielectric is produced by infiltration with a barium titanate nanodispersion and subsequent sintering at 900-1100° C.

Such a method can be problematic owing to the elaborate production and the low thermal stability of the metallization. Production of the dielectric requires temperatures of 900-1100° C. Many metals already have a very high mobility at these temperatures, which together with the large surface tension of the metals can cause the metallization layer to coalesce and form fine droplets. This is observed particularly in the case of a silver or copper metallization. During infiltration with the barium titanate nanodispersion in the second step, nonuniform coating or clogging of the pores can furthermore take place if the dispersion contains sizeable particles or aggregates. In the event of nonuniform coating, it is not possible to use all of the internal surface of the porous substrate, which reduces the useful capacitance of the capacitor and greatly increases the risk of short circuits.

German patent application number 102004052086.0 discloses a method for producing a capacitor, in which a porous conductive substrate is coated fully (on its inner and outer surfaces) with a thin film of a ceramic dielectric. Oxides such as barium titanate (BaTiO₃) are preferably used as the material. The BaTiO₃ is applied by infiltrating the porous substrate with a solution which contains barium and titanium alcoholates, carboxylates or the like. After infiltration, the solution is heat treated (in one or more stages at temperatures of up to about 800° C.) in order to calcine the dissolved precursor compounds to form the oxide. Here, it is desirable to use a maximally concentrated solution (according to the examples 20 wt. % or more) in order to transport the greatest possible quantity of material into the interior of the porous substrate during the infiltration.

Although this procedure has advantages over the prior art as described above, it is not possible to fully eliminate the disadvantages, in particular the possible accumulation of the dielectric ceramic in the interior instead of on the walls of the pores. Such material is not in intimate contact with the conductive substrate, and does not therefore contribute to the energy storage in the capacitor. Instead of the formation of a tight film, accumulation of particles on the pore walls can take place. The resulting defects in the film lead to short circuits in the capacitor, i.e. to an inferior quality of the component.

It is therefore an object of the invention to develop a method for producing a continuous and low-defect coating on a porous, electrically conductive substrate material with a dielectric. The coating should as far as possible reach the entire inner and outer surface of the substrate material, but avoid clogging or unnecessarily filling the pores. The method should be economical and, in particular, suitable for the production of coatings which are used in high capacitance density capacitors.

The object is achieved in that a solution of precursor compounds of the dielectric with a concentration of less than 10 wt. %, expressed in terms of the contribution of the dielectric to the total weight of the solution, is used for coating the porous electrically conductive substrate material.

The invention therefore relates to a method for producing a coating of a porous, electrically conductive substrate material with a dielectric by using a solution of precursor compounds of the dielectric with a concentration of less than 10 wt. %, expressed in terms of the contribution of the dielectric to the total weight of the solution.

The invention also relates to the use of this method to produce a coating as a dielectric in a capacitor, as well as to such a capacitor per se, its production and its use in electrical and electronic circuits.

Contrary to the obvious approaches as explained above, it has surprisingly been found that the use of low-concentration solutions leads to a better coating quality.

When solutions which contain the precursor compounds of the material to be deposited at a concentration of less than 10 wt. %, expressed in terms of the contribution of the dielectric to the total weight of the solution, are used to produce the coatings, then preferential deposition of the material on the walls of the porous substrate can be observed after the thermal post-treatment. The coating material deposits as a tightly closed film on the pore walls, and the accumulation of particulate material is suppressed. Unnecessary and detrimental accumulation in the interior of the pores can therefore no longer be observed. The coating process may be repeated a plurality of times in order to achieve the desired layer thickness, without creating the described undesired accumulations.

The dielectric layers produced in this way have a high thermal, mechanical and electrical load-bearing capacity, and they are therefore suitable particularly for use in high capacitance density capacitors.

The use of electrically conductive substrate materials furthermore offers the advantage that, owing to the pre-existing electrical conductivity of the substrate, no additional coating of the substrate for metallization is necessary. The method therefore becomes simpler and more economical, the capacitors become more robust and are less susceptible to defects.

Suitable substrates preferably have a specific surface (BET surface) of from 0.01 to 10 m²/g, particularly preferably from 0.1 to 5 m²/g.

Such substrates may, for example, be produced from powders having specific surfaces (BET surface) of from 0.01 to 10 m²/g by compression or hot compression at pressures of from 1 to 100 kbar and/or sintering at temperatures of from 500 to 1600° C., preferably from 700 to 1300° C. The compression or sintering is preferably carried out in an atmosphere consisting of air, inert gas (for example argon or nitrogen) or hydrogen, or mixtures thereof, with an atmosphere pressure of from 0.001 to 10 bar.

The pressure used for the compression and/or the temperature used for the heat treatment depend on the materials being used and on the intended material density. A density of from 30 to 50% of the theoretical value is preferably desired in order to ensure sufficient mechanical stability of the capacitor for the intended purpose, together with a sufficient pore fraction for subsequent coating with the dielectric.

It is possible to use powders of all metals or alloys of metals which have a sufficiently high melting point of preferably at least 900° C., particularly preferably more than 1200° C., and which do not enter into any reactions with the ceramic dielectric during the subsequent processing.

The substrates preferably contain at least one metal, preferably Ni, Cu, Pd, Ag, Cr, Mo, W, Mn or Co and/or at least one metal alloy based thereon.

Preferably, the substrate consists entirely of electrically conductive materials.

According to another preferred variant, the substrate consists of at least one nonmetallic material in powder form, which is encapsulated by at least one metal or at least one metal alloy as described above. The nonmetallic material is preferably encapsulated so that no reactions which deteriorate the properties of the capacitor take place between the nonmetallic material and the dielectric.

Such nonmetallic materials may, for example, be Al₂O₃ or graphite. Nevertheless, SiO₂, TiO₂, ZrO₂, SiC, Si₃N₄ or BN are also suitable. All materials which, owing to their thermal stability, avoid further reduction of the pore fraction due to sintering of the metallic material during heat treatment of the dielectric are suitable.

The substrates used according to the invention may have a wide variety of geometries, for example cuboids, plates or cylinders. Such substrates can be produced in various dimensions, preferably of from a few mm to a few dm, and can therefore be perfectly matched to the relevant application. In particular, the dimensions can be tailored to the required capacitance of the capacitor.

The substrates are connected to a contact. The contacting may preferably be carried out by introducing an electrically conductive wire or strip directly during the aforementioned production of the substrate. As an alternative, contacting may also be carried out by forming an electrically conductive connection between an electrically conductive wire or strip and a surface of the substrate, for example by soldering or welding.

The porous electrically conductive substrates employed according to the invention serve as the first electrode and at the same time as a substrate for the dielectric.

All materials conventionally usable as dielectrics may be employed.

The dielectrics used should have a dielectric constant of more than 100, preferably more than 500.

The dielectric preferably contains oxide ceramics, preferably of the perovskite type, with a composition that can be characterized by the general formula AₓB_{y}O₃. Here, A and B denote monovalent to hexavalent cations or mixtures thereof, preferably Mg, Ca, Sr, Ba, Y, La, Ti, Zr, V, Nb, Ta, Mo, W, Mn, Zn, Pb or Bi, x denotes a number of from 0.9 to 1.1 and y denotes a number of from 0.9 to 1.1. A and B in this case differ from each other.

It is particularly preferable to use BaTiO₃. Other examples of suitable dielectrics are SrTiO₃, (Ba₁₋ₓSrₓ)TiO₃ and Pb(ZrₓTi₁₋ₓ)O₃, where x denotes a number of between 0.01 and 0.99.

In order to improve specific properties such as the dielectric constant, resistivity, breakdown strength or long-term stability, the dielectric may also contain dopant elements in the form of their oxides, in concentrations advantageously of between 0.01 and 10 atomic %, preferably from 0.05 to 2 atomic %. Examples of suitable dopant elements are elements of the 2^{nd} main group, in particular Mg and Ca, and of the 4^{th} and 5^{th} periods of the subgroups of the periodic table, for example Sc, Y, Ti, Zr, V, Nb, Cr, Mo, W, Mn, Fe, Co, Ni, Cu, Ag and Zn, as well as lanthanides such as La, Ce, Pr, Nd, Sm, Eu, Gd, Tb, Dy, Ho, Er, Tm, Yb and Lu.

The dielectric is deposited according to the invention on the substrates from a solution of precursor compounds of the dielectric (so-called sol-gel method, also referred to as chemical solution deposition). The provision of a homogeneous solution is particularly advantageous compared with the use of a dispersion, so that clogging of pores and nonuniform coating cannot occur even in the case of sizeable substrates. To this end, the porous substrates are infiltrated with solutions that can be produced by dissolving the corresponding elements or their salts in solvents.

Salts which may preferably be used are oxides, hydroxides, carbonates, halides, acetylacetonates or derivatives thereof, salts of inorganic acids having the general formula M(R—COO)ₓ with R=H, methyl, ethyl, propyl, butyl or 2-ethylhexyl and x=1, 2, 3, 4, 5 or 6, salts of alcohols having the general formula M(R—O)ₓ with R=methyl, ethyl, propyl, isopropyl, butyl, sec-butyl, isobutyl, tert-butyl, 2-ethylhexyl, 2-hydroxyethyl, 2-aminoethyl, 2-methoxyethyl, 2-ethoxyethyl, 2-butoxyethyl, 2-hydroxypropyl or 2-methoxypropyl and x=1, 2, 3, 4, 5 or 6, of the aforementioned elements (here denoted as M) or mixtures of these salts. Alcoholates and/or carboxylates of barium and titanium are preferably used.

Solvents which may preferably be used are water, carboxylic acids having the general formula R—COOH with R=H, methyl, ethyl, propyl, butyl or 2-ethylhexyl, alcohols having the general formula R—OH with R=methyl, ethyl, propyl, isopropyl, butyl, sec-butyl, isobutyl, tert-butyl or 2-ethylhexyl, glycol derivates having the general formula R¹—O—(C₂H₄—O)ₓ—R² with R¹ and R²=H, methyl, ethyl or butyl and x=1, 2, 3 or 4, 1,3-dicarbonyl compounds such as acetyl acetone or acetyl acetonate, aliphatic or aromatic hydrocarbons, for example pentane, hexane, heptane, benzene, toluene or xylene, ethers such as diethyl ether, dibutyl ether or tetrahydrofuran, or mixtures of these solvents. It is particularly preferable to use glycol ethers such as methyl glycol or butyl glycol.

According to the invention, the employed solution of the precursor compounds of the dielectric has a concentration of less than 10 wt. %, preferably less than 6 wt. %, particularly preferably from 2 to 6 wt. %, respectively expressed in terms of the contribution of the dielectric to the total weight of the solution. The contribution of the dielectric to the total weight of the solution is calculated as the quantity of material e.g. BaTiO₃ remaining after the calcination, expressed in terms of the quantity of solution used.

The infiltration of the substrates may be carried out by immersing the substrates in the solution, by pressure impregnation or by spraying it on. Complete wetting of the inner and outer surfaces of the substrates should be ensured.

The substrates impregnated with the solution are subsequently heat treated in the conventional way in ovens at a temperature of from 500 to 1500° C., preferably from 600 to 1000° C., particularly preferably at about 700 to 900° C., in order to calcine the dissolved precursor compounds to form the oxide.

Inert gases (for example argon, nitrogen), hydrogen, oxygen or steam, or mixtures of these gases, may be used as the atmosphere with an atmosphere pressure of from 0.001 to 10 bar.

In this way, thin films with a thickness of preferably from 5 to 30 nm are obtained over the entire inner and outer surfaces of the porous substrates. As far as possible, the entire inner and outer surfaces should be covered in order to ensure a maximal capacitance of the capacitor.

In order to achieve the desired layer thickness of preferably from 50 to 500 nm, particularly preferably from 100 to 300 nm, the coating process is repeated a plurality of times if necessary, for example up to 20 times. In order to save time and energy, the coating need not be fully calcined at a high temperature during each repetition, for example 800° C. A comparable quality of the coating is obtained even when the coating is firstly heat treated only at a low temperature, for example at 200 to 600° C., particularly preferably at about 400° C., and not fully calcined at a high temperature, as described above, until after all repetitions of the coating process have been completed.

In order to improve the electrical properties of the dielectric, it may be necessary to carry out another heat treatment after the sintering, at a temperature of between 200 and 600° C. in an atmosphere having an oxygen content of from 0.01 % to 25%.

In one exemplary embodiment, the coating of a porous, electrically conductive substrate material with a dielectric is carried out according to the invention as follows:

In the conventional way, the precursor compounds of the dielectric which are to be used according to the invention are dissolved in the solvent or solvents simultaneously or successively, or first individually, optionally with cooling or with heating. The production of such solutions is prescribed in the literature, for example in R. Schwartz “Chemical Solution Deposition of Ferroelectric Thin Films” in Materials Engineering 28, Chemical Processing of Ceramics, 2^{nd} edition 2005, pp. 713-742. Any remaining solid is removed by filtration. Operation is preferably carried out at room temperature. Excess solvent is subsequently distilled off if need be, for example by means of a rotary evaporator, until the desired concentration of the solution is achieved. Finally, the solution is preferably filtered to remove suspended particles.

The porous shaped bodies are immersed in this solution. A vacuum of from 0.1 to 900 mbar, preferably about 100 mbar, may additionally be applied for 0.5 to 10 min, preferably about 5 min, followed by re-aeration in order to remove trapped air bubbles. The impregnated shaped bodies are removed from the solution and excess solution is dripped off. Conventionally, the shaped bodies are subsequently first dried, preferably for 5 to 60 min at 50 to 200° C. and then hydrolyzed for 5 to 60 min at 300 to 500° C., for example in humid nitrogen. They are finally calcined for 10 to 120 min at the temperatures indicated above, preferably in dry nitrogen.

The sequence of impregnation/drying/calcining is optionally repeated until the desired layer thickness is achieved.

The coatings produced according to the method described above comprise a continuous and low-defect layer of the dielectric on virtually the entire inner and outer surfaces of the substrate material.

A coating is low-defect in the context of this invention when the resistivity of the coating is more than 10⁸ Ω·cm, preferably more than 10¹¹ Ω·cm. The resistance of the coating may, for example, be determined via impedance spectroscopy. With a known specific surface of the substrate (conventionally determined via BET measurement) and a known layer thickness of the coating (conventionally determined via electron microscopy), the measured resistance can be converted into the resistivity in the manner known to the person skilled in the art.

The coatings according to the invention may be used as a dielectric in a capacitor.

According to the invention, an electrically conductive second layer is applied as a reference electrode on the dielectric. It may be any electrically conductive material conventionally used for this purpose according to the prior art. For example, manganese dioxide or electrically conductive polymers such as polythiophenes, polypyrroles, polyanilines or derivatives of these polymers are used. A better electrical conductivity and therefore lower internal resistance (ESR, equivalent series resistance) of the capacitors is obtained by applying metal layers as the reference electrode, for example layers of copper according to DE-A-10325243.

The external contacting of the reference electrode may also be carried out by any technique conventionally used for this purpose according to the prior art. For example, the contacting may be carried out by graphitizing, applying conductive silver and/or soldering. The contacted capacitor may then be encapsulated in order to protect it against external effects.

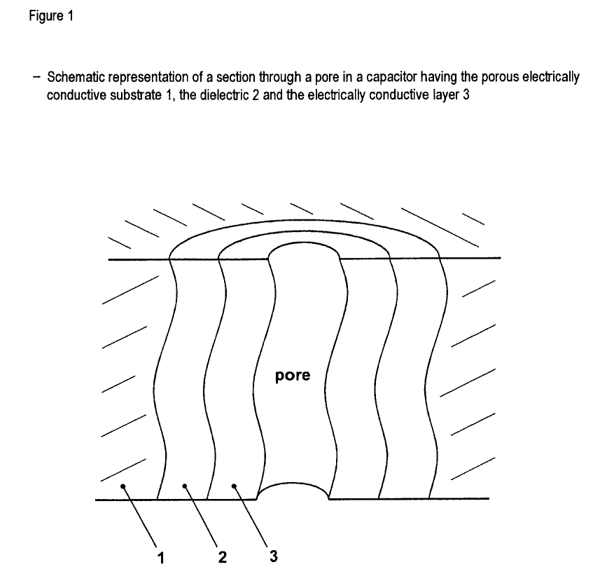

The capacitors produced according to the invention comprise a porous electrically conductive substrate, on virtually all of whose inner and outer surfaces a continuous and low-defect layer of a dielectric and an electrically conductive layer are applied. The diagram of such a capacitor is represented by way of example in FIG. 1.

The capacitors produced according to the invention exhibit an improved capacitance density compared with the conventional tantalum capacitors or multilayer ceramic capacitors, and they are therefore suitable for the storage of energy in a wide variety of applications, especially in those which require a high capacitance density. Their production method allows simple and economical production of capacitors having significantly larger dimensions and a correspondingly high capacitance.

Such capacitors may, for example, be used as smoothing or storage capacitors in electrical power engineering, as coupling, filtering or small storage capacitors in microelectronics, as a substitute for secondary batteries, as primary energy storage units for mobile electrical devices, for example electrical power tools, telecommunication applications, portable computers, medical devices, for uninterruptible power supplies, for electrical vehicles, as complementary energy storage units for electrical vehicles or hybrid vehicles, for electrical elevators, and as buffer energy storage units to compensate for power fluctuations of wind, solar, solar thermal or other power plants.

The invention will be explained in more detail with reference to the following exemplary embodiments, but without thereby implying any limitation.

### EXAMPLES

### Example 1

### Production of the Substrate Material

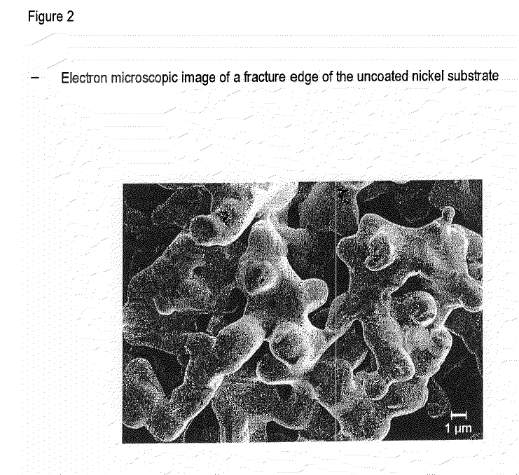

A nickel wire and nickel powder (Inco type T255) were introduced into a metal plate having cuboid cavities with dimensions of 10×10×2 mm and were uniformly compressed mechanically. They were subsequently sintered for 30 min at 800° C. in a hydrogen atmosphere. A solid substrate was obtained with a pore volume fraction of approximately 70% and a BET surface of 0.1 m²/g. FIG. 2 shows an electron microscopic image of the uncoated nickel substrate.

### Example 2

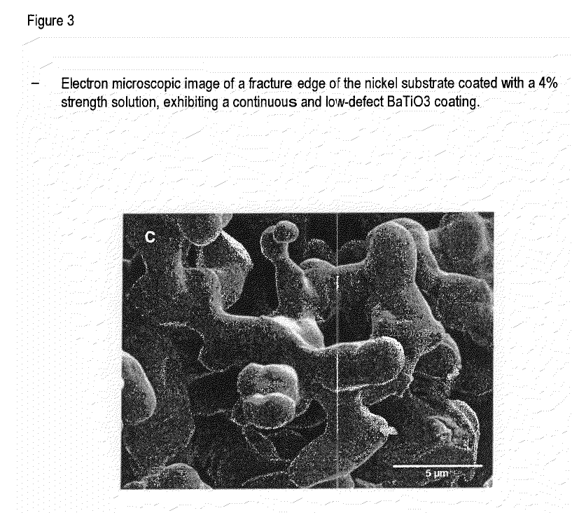

10.0 g of barium oxide were dissolved portionwise over 30 min in 100 ml of methanol with ice cooling. A minor quantity of solid was removed by filtration. 50 g of methylene glycol and 18.5 g of titanium tetraisopropylate were subsequently added dropwise and stirred for 30 min. A solution of 4.7 g water in 50 g methylene glycol was then added dropwise over 15 min and stirred for a further 4 h at room temperature. Methanol and isopropanol were distilled off in a rotary evaporator at 40° C. and 200 mbar. The resulting solution was adjusted to a BaTiO3 content of 4 wt. % with methylene glycol. The solution was then filtered through a 0.2 μm filter to remove suspended particles.
The porous shaped bodies produced according to Example 1 were immersed in the solution described above. A vacuum of 100 mbar was applied for 5 min, followed by re-aeration in order to remove trapped air bubbles. The impregnated shaped bodies were removed from the solution and excess solution was dripped off. The shaped bodies were subsequently first dried for 25 min at 150° C., then hydrolyzed for 30 min at 400° C. in humid nitrogen and finally calcined for 20 min at 800° C. in dry nitrogen.
The sequence of impregnation/drying/calcining was carried out 20 times in total. A continuous and low-defect BaTiO₃ coating with a thickness of approximately 200 nm was obtained on the inner and outer surfaces of the shaped bodies. FIG. 3 shows an electron microscopic image of a continuous and low-defect BaTiO₃ coating made from a 4% strength solution.

### Example 3

20.6 g of barium oxide were dissolved portionwise in 212 ml of methanol over 45 min with ice bath cooling. A minor quantity of solid was removed by filtration. A solution of 17.9 g ethanolamine in 100 ml butyl glycol was added to the clear filtrate and the weakly yellow solution was stirred for 2.5 h at room temperature. Methanol was distilled off in a rotary evaporator at a pressure of 2 mbar and 55° C. 45.2 g of titanium tetrabutylate were dissolved in 392 ml of butyl glycol and 26.8 g of acetylacetone were added dropwise. The intensely yellow clear solution was heated to reflux for 2 h. After cooling to room temperature, the barium aminoethylate solution was added and stirred for 1 h. The solution was adjusted to a content of 4 wt. % (expressed in terms of BaTiO3) with butyl glycol.
Operation was continued with the solution similarly as in Example 2. A continuous and low-defect BaTiO₃ coating was likewise obtained.

### Example 4

The coated shaped bodies of Example 3 were immersed in a 30% strength solution of manganese(II) nitrate hydrate in water. The fully impregnated shaped bodies were taken from the solution and heat treated in air for 10 minutes, respectively, first at 150° C. and then at 250° C. The impregnation/heat treatment sequence was carried out 10 times in all.
For contacting, the shaped bodies were immersed first in a graphite solution and subsequently in a silver dispersion and respectively dried for 1 h at 150° C. The resulting capacitors had a capacitance of 1 mF. The resistivity of the BaTiO₃ layer was >10⁹ Ωcm.

### Example 5

### Comparative Example

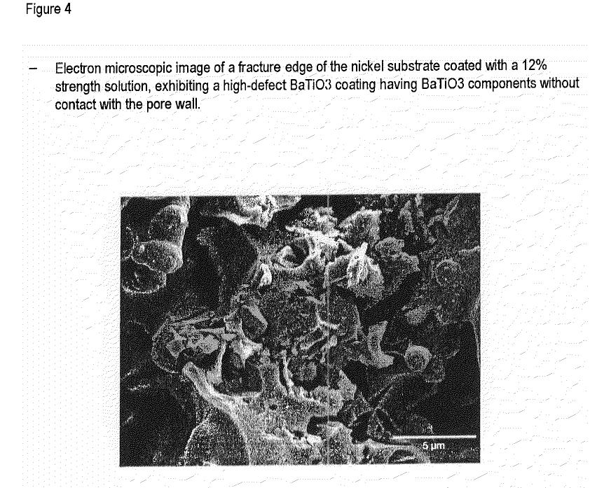

A solution with a concentration of 12 wt. % (expressed in terms of BaTiO₃) was prepared similarly as in Example 2 and this solution was used for coating shaped bodies according to Example 1. A high-defect BaTiO₃ coating having significant BaTiO₃ components without contact with the pore wall was obtained. FIG. 4 shows an electron microscopic image of a high-defect BaTiO₃ coating having BaTiO₃ components without contact with the pore wall, made from a 12% solution.

### Example 6

### Comparative Example

Operation was carried out similarly as in Example 4 with the coated shaped bodies from Example 5. The resulting capacitors had a capacitance of 0.1 mF. The resistivity of the BaTiO₃ layer was <10⁷ Ωcm.

1. A method for producing a coating of a porous, electrically conductive substrate material with a dielectric by using a solution of precursor compounds of the dielectric with a concentration of less than 10 wt. %, expressed in terms of the contribution of the dielectric to the total weight of the solution.

2. The method according to claim 1, wherein the coating takes place by infiltration of the porous substrate material with the solution and subsequent heat post-treatment.

3. The method according to claim 1, wherein the coating is repeated a plurality of times until the desired layer thickness is achieved.

4. The method according to claim 1, wherein the substrate material has a specific surface of from 0.01 to 10 m²/g.

5. The method according to claim 1, wherein the substrate material comprises at least one metal or at least one metal alloy which has a melting point of at least 900° C.

6. The method according to claim 1, wherein the substrate material comprises Ni, Cu, Pd, Ag, Cr, Mo, W, Mn or Co and/or at least one metal alloy based thereon.

7. The method according to claim 1, wherein the substrate consists of at least one nonmetallic material in powder form, which is encapsulated with at least one metal or at least one metal alloy.

8. The method according to claim 7, wherein the nonmetallic material is Al₂O₃ or graphite.

9. The method according to claim 1, wherein the dielectric comprises a dielectric with a dielectric constant of more than 100.

10. The method according to claim 1, wherein the dielectric comprises an oxide ceramic of the perovskite type having the composition AₓB_{y}O₃, where A and B denote monovalent to hexavalent cations or mixtures thereof, x denotes a number of from 0.9 to 1.1 and y denotes a number of from 0.9 to 1.1.

11. The method according to claim 1, wherein the dielectric comprises BaTiO₃.

12. The method according to claim 1, wherein the dielectric comprises one or more dopant elements in the form of their oxides at concentrations of between 0.01 and 10 atomic %.

13. A dielectric in a capacitor comprising the coating produced according to the method according to claim 1.

14. A capacitor which contains a porous, electrically conductive substrate, on the inner and outer surfaces of which a first layer of a dielectric, produced according to a method according to claim 1, and a second electrically conductive layer are applied.

15. A method for producing capacitors, wherein on a porous, electrically conductive substrate provided with a contact, a first layer of a dielectric, produced according to a method according to claim 1, and a second layer of an electrically conductive material provided with a contact are applied on its inner and outer surfaces.

16. A method of using the capacitor according to claim 14 in electrical and electronic circuits.
